(19) United States
(12) Patent Application Publication
(10) Pub. No.: US 2005/0260118 A1
(43) Pub. Date: Nov. 24, 2005

(54) Mesoporous carbon films and methods of preparation thereof

(76) Inventors: Yunfeng Lu, New Orleans, LA (US); Jiebin Pang, New Orleans, LA (US)

Correspondence Address: OLSON & HIERL, LTD., 20 NORTH WACKER DRIVE, 36TH FLOOR, CHICAGO, IL, 60606, US

(21) Appl. No.: 10/849,952

(22) Filed: May 20, 2004

(51) Int. Cl. C01B 31/00

(52) U.S. Cl. 423/445 R

(57) ABSTRACT

A mesoporous carbon film having a unimodal pore structure comprises a film of carbon defining an open network of interconnected primary pores arrayed in a uniform, random manner throughout the film. The pores in the film have an average pore diameter in the range of about 2 to about 3 nm, and the diameters of the pores have a substantially unimodal pore diameter distribution. Not more than about 20% of the pores in the film have a diameter of less than about 1 nm. The mesoporous carbon films can be prepared by depositing a thin film of an aqueous sol-gel composition comprising a polysiloxane gel precursor, and a water soluble carbohydrate onto a substrate, heating the thin film to carbonize the carbohydrate and form a carbon/silica nanocomposite film, and removing the silica from the carbon/silica nanocomposite film to provide a continuous mesoporous carbon film. Suspending colloidal silica in the aqueous sol-gel composition prior to depositing the thin film on the substrate affords a mesoporous carbon film having a hierarchical, bimodal pore structure, which includes spherical secondary pores randomly distributed throughout the film and interconnecting with the network of primary pores.

### FIELD OF THE INVENTION

This invention relates generally to mesoporous carbon films. More particularly the invention relates to mesoporous carbon films having unimodal and hierarchical, bimodal pore structures and to methods of preparing such mesoporous carbon films.

### BACKGROUND

With recent developments in nanotechnology, nanoporous materials have garnered increased interest. Nanoporous carbon films and membranes are useful in a number of applications, such as gas separations, ultrafiltration, sensors, and fuel cells. Current methods for synthesizing nanoporous carbon films, such as chemical vapor deposition, pulsed laser deposition, spray coating, and ultrasonic deposition, often result in microporous carbon films, i.e., with average pore diameters of less than 1 nm. Although microporous carbon films and membranes are useful for gas separations, the small pore diameters can limit applications where relatively larger molecules must pass through the pores.

Mesoporous materials (i.e., materials with average pore diameters of about 2 to about 50 nm) allow transport of larger molecules through the pores and enhance internal diffusion of molecules within the material. Template-based synthesis has been utilized to prepare mesoporous materials such as mesoporous metal films, mesoporous semiconductor films, and the like.

Nanoporous carbon materials are conventionally prepared through carbonization of carbon precursors, such as coal, coconut shell, polyfurfuryl alcohol, phenolic resin, and sugars. Recent progress has been made in the synthesis of nanoporous carbon materials through either a “two-step” process or a “direct” process. The two-step synthesis technique involves the formation of nanoporous silica templates with ordered periodic pore structure through self-assembly of silicate and surfactant, and subsequent infiltration of carbon precursors into the nanoporous silica. Subsequent carbonization of the carbon precursors and removal of the silica template provides a nanoporous carbon material. The two-step synthesis allows for precise pore-structure control by replicating the pore structure of the silica templates. However, the two-step process is typically limited by incomplete infiltration of the carbon precursors into the templates, by the formation of a nonporous carbon layer on an exterior surface of the template, and by the difficulty of controlling the macroscopic morphology of the film. Other template directed syntheses of nanoporous carbon materials using zeolite templates, clay templates, and colloidal silica templates, have typically provided powder and monolithic materials rather than continuous films.

Various synthetic methods have been developed to produce nanoporous silica with a variety of morphological and topological characteristics including hexagonal mesoporous materials with parallel arrays of relatively uniform diameter cylindrical pores, as well as cubic mesoporous materials having interconnected pore structures. These methods are typically inexpensive and afford templates with readily controllable pore structures. A number of different nanostructured materials, such as polymers, metals, metallic alloys, semiconductors, and other inorganic compounds, have been synthesized in mesoporous silica templates.

A direct synthesis technique for preparing nanoporous carbon involves carbonization of organic polymer blends. The Foley research group pioneered the synthesis of mesoporous carbon films by carbonizing blends of poly(ethylene glycol) (PEG) and poly(furfuryl alcohol) (PFA) (see e.g., Strano et al., J. Membrane Sci., 2002; 198:173-186). Removal of the PEG during the carbonization process reportedly results in mesoporous carbon thin films. The Foley method provides mesoporous carbon films at relatively low-cost; however, a high percentage (70% or greater) of the pores of these films have a diameter of less than 1 nm (i.e., in the micropore size range), which limits the utility of this polymer blend method.

There is an ongoing need for improved mesoporous carbon films having a relatively low percentage of pores with diameters of less than about 1 nm, and having an open, relatively uniform, unimodal pore structure. The present invention fulfills this need.

### SUMMARY OF THE INVENTION

A mesoporous carbon film of the present invention comprises a film of carbon, which defines an open network of interconnected primary pores arrayed in a uniform, random manner throughout the film. The primary pores have an average pore diameter of about 2 to about 3 nm, with a substantially unimodal pore diameter distribution. Not more than about 20% of the pores have a diameter of less than about 1 nm. The interconnected network of primary pores is open to the exterior surfaces of the film, thus providing pore accessibility that is particularly useful for membrane filtration, catalysis, and hydrogen storage applications, for example.

In a preferred embodiment, a mesoporous carbon film has a substantially unimodal pore structure, in which preferably at least about 90% of the pores have diameters within the range of about 1 to about 3 nm. A particularly preferred unimodal mesoporous carbon film comprises a film of carbon defining an open network of interconnected pores arrayed in a uniform, random manner throughout the film. The pores have an average pore diameter in the range of about 2 to about 3 nm. The diameters of the pores in the film have a substantially unimodal pore diameter distribution. Not more than about 20% of the pores have a diameter of less than about 1 nm, and at least about 90% of the pores have a diameter in the range of about 1 to about 3 nm. The film preferably has a specific surface area in the range of about 300 to about 3000 m²/g, more preferably about 2000 to about 3000 m²/g. Preferably, the film has a specific pore volume in the range of about 0.35 to about 1.5 cm³/g, more preferably about 0.7 to about 1.5 cm³/g, most preferably about 1 to about 1.5 cm³/g.

Another preferred embodiment is a mesoporous carbon film having a hierarchical, substantially bimodal pore structure, which comprises a film of carbon defining an open network of interconnected primary pores arrayed in a uniform, random manner throughout the film, and further defining a plurality of substantially spherical secondary pores also arrayed in a uniform, random manner throughout the film. The primary pores have an average pore diameter in the range of about 2 to about 3 nm and the secondary pores preferably have an average diameter in the range of about 10 to about 500 nm, more preferably about 20 to about 100 nm. The diameters of the primary pores have a substantially unimodal pore diameter distribution and preferably not more than about 20% of the primary pores have a diameter of less than about 1 nm. The primary and secondary pores of the bimodal mesoporous carbon films of the invention interconnect with one another.

The mesoporous carbon films of the present invention can be prepared by depositing an aqueous sol-gel composition comprising a polysiloxane precursor (e.g., from acid catalyzed condensation of tetraethyl orthosilicate) and a water soluble carbohydrate (e.g., glucose, mannose, fructose, sucrose, and the like) onto a substrate to form a carbohydrate/silica nanocomposite precursor film. The precursor film is then heated at a temperature in the range of about 800 to about 1000° C. for a time sufficient to carbonize the carbohydrate to form a carbon/silica nanocomposite film. The silica is then removed from the carbon/silica nanocomposite to provide a continuous mesoporous carbon film having a network of interconnected pores open to the exterior surfaces of the film. The sol-gel composition is a homogeneous mixture containing about 30 to about 40% by weight water, about 35 to about 50% of a polysiloxane gel precursor on a silica equivalent weight basis, and about 4 to about 30% of water soluble carbohydrate on a carbon equivalent weight basis. The relative amounts of polysiloxane gel precursor and water soluble carbohydrate in the sol-gel composition are selected so that the carbon/silica nanocomposite film preferably has a calculated carbon to silica weight ratio in the range of about 1:1 to about 1:7. The carbon to silica weight ratio of the carbon/silica nanocomposite film can have a measured value in the range of about 1:1 to about 1:11, as determined by weight loss of the sample during thermogravimetric analysis (TGA).

A mesoporous carbon film having a hierarchical, bimodal pore structure can be prepared by suspending colloidal silica in the aqueous sol-gel composition prior to depositing the sol-gel composition on the substrate. The bimodal films have substantially spherical secondary pores randomly distributed throughout the film and interconnecting with the open network of primary pores.

The mesoporous carbon films of the present invention are useful in a variety of applications, such as, ultrafiltration membranes, gas separation membranes, catalyst supports, hydrogen storage media, and the like.

### BRIEF DESCRIPTION OF THE DRAWINGS

In the drawings, FIG. 1 schematically depicts the formation of a unimodal mesoporous carbon film of the invention from a sucrose/silica nanocomposite film;

FIG. 2 schematically depicts the formation of a hierarchical, bimodal mesoporous carbon film of the invention;

FIG. 3 depicts TGA curves of a mesoporous carbon film of the invention prepared from a carbon/silica nanocomposite film; the TGA curves before and after removal silica from the nanocomposite are provided;

FIG. 4 shows N₂ sorption isotherms of (a) the carbon/silica nanocomposite, (b) porous silica produced by the removal of carbon from a carbon/silica nanocomposite, and (c) porous carbon produced by removal of silica from a carbon/silica nanocomposite (adsorption: close symbols; desorption: open symbols); Inset: Pore size distributions of the mesoporous silica (d) and mesoporous carbon film (e) calculated using the density functional theory (DFT) (Software from Micrometritics);

FIG. 5 shows a TEM image of a unimodal mesoporous carbon film of Example 1;

FIG. 6 shows a TEM image of a bimodal mesoporous carbon film prepared in Example 2, and

FIG. 7 provides a graph of volume of adsorbed hydrogen versus pressure for a hydrogen storage medium comprising a mesoporous carbon membrane material of the present invention.

### DETAILED DESCRIPTION OF PREFERRED EMBODIMENTS

The term “nanoporous” as used herein and in the appended claims, when used in reference to the pore structure of a porous carbon film, means that the pores in the film have diameters ranging from less than one nanometer up to about 100 nm. Nanoporous materials can have pores in the microporous size range (less than 2 nm), in the mesoporous size range (about 2 to about 50 nm) and in the macroporous size range (greater than 50 to about 100 nm).

The term “unimodal” as used herein and in the appended claims, when used in reference to the pore structure of a mesoporous carbon film, means that there is substantially only one peak in a plot of number of pores versus pore diameter and that the distribution of pore size (i.e., pore diameters) in the film is generally relatively narrow. Preferably, at least about 90% of the pores in the film have a diameter that falls within the range of about 1 to about 3 nm, as determined by standard methods, such as gas absorption, and electron microscopy. The pores are substantially uniformly spatially distributed within the carbon film and at the exterior surfaces thereof.

The phrase “hierarchical, bimodal” as used herein and in the appended claims, when used in reference to the pore structure of a mesoporous carbon film, means that the film includes pores of two different, distinct pore structures, including interconnecting network of primary pores in the size range of about 2 to about 3 nm average pore diameter, and substantially spherical secondary pores in the mesoporous to macroporous size range. The primary pores have a narrow pore size distribution wherein preferably at least about 90% of the primary pores in the film have a diameter that falls within about the 1 to about 3 nm, as determined by standard gas absorption or electron microscopic methods. The secondary pores are roughly spherical in shape and interconnect with the primary pores. Both the primary and secondary pores are substantially uniformly spatially distributed within the carbon film and at the surfaces thereof.

The phrase “open network” as used herein and in the appended claims, as applied to an interconnected network of pores in a carbon film means that at least a portion of the pores are open at the exterior surfaces of the film, so that substances (e.g., gases or liquid materials) can pass though the film via the network of pores. Liquid and gaseous materials of appropriate size relative to the pore size can enter pores in one exterior surface, pass though pores in the interior of the film, and pass out through pores on the opposite exterior surface of the film.

The term “carbonize” and grammatical variations thereof, as used herein and in the appended claims in reference to carbohydrates means that the carbohydrate is dehydrated at elevated temperature to form elemental carbon therefrom.

The mesoporous carbon films of the present invention include a unimodal, open network of interconnecting primary pores having an average pore diameter of about 2 to about 3 nm. A particularly preferred unimodal mesoporous carbon film comprises a film of carbon defining an open network of interconnected pores arrayed in a uniform, random manner throughout the film. The pores have an average pore diameter in the range of about 2 to about 3 nm. The diameters of the pores in the film have a substantially unimodal pore diameter distribution in which preferably at least about 90% of the pores have diameters within the range of about 1 to about 3 nm, and not more than about 20% of the pores have a diameter of less than about 1 nm.

The unimodal mesoporous carbon films of the present invention preferably have a specific surface area in the range of about 300 to about 3000 m²/g, more preferably about 2000 to about 3000 m²/g.

The unimodal mesoporous carbon films of the present invention preferably have a specific pore volume in the range of about 0.35 to about 1.5 cm³/g, more preferably about 0.7 to about 1.5 cm³/g, most preferably about 1 to about 1.5 cm³/g.

Another preferred embodiment is a mesoporous carbon film having a hierarchical, bimodal pore structure, which comprises a film of carbon defining an open network of interconnected primary pores arrayed in a uniform, random manner throughout the film, and further defining a plurality of substantially spherical secondary pores also arrayed in a uniform, random manner throughout the film. The primary pores have an average pore diameter in the range of about 2 to about 3 nm and the secondary pores preferably have an average diameter in the range of about 10 to about 500 nm, more preferably about 20 to about 100 nm. The diameters of the primary pores have a substantially unimodal pore diameter distribution and not more than about 20% of the primary pores have a diameter of less than about 1 nm. The primary and secondary pores of the bimodal mesoporous carbon films of the invention interconnect with one another.

The bimodal mesoporous carbon films of the present invention preferably have a specific surface area in the range of about 300 to about 3000 m²/g, more preferably about 1000 to about 3000 m²/g, most preferably about 2000 to 3000 m²/g.

The bimodal mesoporous carbon films of the present invention preferably have a specific pore volume in the range of about 1 to about 2 cm³/g, more preferably about 1 to about 1.5 cm³/g.

The unimodal and bimodal mesoporous carbon films of the present invention preferably have an average thickness in the range of about 0.5 to about 2 microns, more preferably about 1 to about 1.5 microns.

A method aspect of the present invention provides for the direct synthesis of continuous mesoporous carbon films by depositing a thin film of an aqueous carbohydrate/silica sol-gel composition onto a substrate, heating the thin film at a temperature in the range of about 800 to about 1000° C. for a time sufficient to carbonize the carbohydrate and form a carbon/silica nanocomposite film on the substrate, and then removing the silica from the carbon/silica nanocomposite film to afford the mesoporous carbon film. The sol-gel composition is a homogeneous mixture containing about 30 to about 40% by weight water, about 35 to about 50% of a polysiloxane gel precursor on a silica equivalent weight basis, and about 4 to about 30% of water soluble carbohydrate on a carbon equivalent weight basis. The relative amounts of polysiloxane precursor and water soluble carbohydrate in the sol-gel composition are selected so that the carbon/silica nanocomposite film has a calculated carbon to silica weight ratio in the range of about 1:1 to about 1:7, which corresponds to ratio in the range of about 1:1 to about 1:11 as determined by weight loss of a sample of the film observed during thermogravimetric analysis.

Surprisingly, the average pore diameter of the primary network of pores remains relatively constant as the carbon to silica weight ratio is varied. Increasing the relative amount of silica in the sol-gel ultimately results in more pores in the resulting carbon film, but still having an average pore diameter of about 2 to about 3 nm. The specific surface area and specific pore volume, on the other hand, vary as the carbon to silica ratio is altered. For example, the specific pore volume increases as the calculated ratio of carbon to silica is decreased from 1:1 until a maximum value is reached at a calculated carbon to silica ratio of about 1:2.3, after which point the volume begins to decrease as the ratio approaches 1:7. Similarly, the specific surface area increases as the ratio of carbon to silica decreases until the maximum surface area is reached at a calculated carbon to silica ratio of about 1:2.3 (1:2.8 as measured by TGA), and then the surface area decreases as the calculated carbon to silica weight ratio deceases from about 1:2.3 down to about 1:7.

The resulting mesoporous carbon film comprises a film of carbon defining an open network of interconnected pores arrayed in a uniform, random manner throughout the film. The pores have an average pore diameter in the range of about 2 to about 3 nm, and the diameters of the pores have a substantially unimodal pore diameter distribution. Not more than about 20% of the pores have a diameter of less than about 1 nm.

Optionally, a surfactant, preferably a cationic surfactant, can be included in the sol-gel composition to further control and manipulate the pore structure of the resulting silica framework. A preferred cationic surfactant is cetyltrimethylammonium bromide (CTAB) (see, for example, U.S. Pat. No. 5,858,457 to Brinker et al. which describes preparation of mesoporous silica using surfactant templating, incorporated herein by reference).

The sol-gel thin film can be deposited on the substrate by any film deposition method suitable for use with sol-gel compositions. Suitable methods of depositing thin films of sol-gel compositions are well known in the coatings art and include spin coating, dip coating, spray coating, roll coating, gravure coating, and the like.

A preferred method of depositing a thin film of sol-gel composition onto a substrate is spin coating, particularly when the substrate is flat and amenable to the spin coating process. The spin coating process involves spinning the substrate, preferably at a rate of at least about 500 revolutions per minute (rpm), while depositing the sol-gel composition onto the substrate at or near the axis of rotation of the substrate. The sol-gel composition spreads and thins due to the centrifugal force from the spinning substrate. Typically spinning rates of 1000 to 2000 rpm are utilized to spread and thin the sol-gel films. Evaporation of solvent from the sol-gel composition during the spin coating process leads to further thinning of the films.

The polysiloxane gel precursor is preferably prepared in situ by acid catalyzed condensation of an orthosilicate, preferably an organic orthosilicate ester such as tetraethyl orthosilicate (TEOS), methyltriethyl orthosilicate (MTES), and the like. For example, a solution of TEOS in aqueous hydrochloric acid can be heated for a period of time at a temperature sufficient to initiate condensation of the orthosilicate to form a polysiloxane gel precursor, preferably by heating the TEOS for about 6 hours at about 60° C.

The water soluble carbohydrate can be any carbohydrate that is soluble in water and can be dehydrated at high temperature (e.g., at a temperature in the range of about 800 to about 1000° C.) to form elemental carbon. Preferred carbohydrates include glucose, mannose, fructose, sucrose, and the like. Sucrose is a particularly preferred water soluble carbohydrate.

As noted above, the average pore diameter (i.e., pore size) of the mesoporous carbon film is relatively constant as the carbon to silica ratio in the sol-gel is varied, while the specific surface area and specific pore volume pass through a maximum value at a carbon to silica equivalent weight ratio of about 3:5.

A preferred method of preparing a unimodal mesoporous carbon film of the invention is schematically illustrated in FIG. 1. A continuous sucrose/silicate nanocomposite precursor film is prepared by spin coating a homogeneous sucrose/silicate aqueous sol-gel composition onto a substrate. The precursor film is then carbonized by heating at a temperature in the range of about 800 to about 1000° C. to dehydrate the carbohydrate to form elemental carbon, affording a carbon/silica nanocomposite film. Subsequent removal of the silica from the nanocomposite, for example, by etching with dilute aqueous hydrofluoric acid (HF), results in a mesoporous carbon thin film of the invention having a high surface area, high pore volume, and substantially uniform pore size distribution, including a network interconnecting of primary pores in open communication with the exterior surfaces of the film.

One preferred procedure for preparing a unimodal mesoporous carbon film of the invention (on a 1 mole basis for the orthosilicate) follows. Any desirable amount of the film can be prepared by direct scale-up of the molar amounts provided below.

About one mole of an orthosilicate such as tetraethyl orthosilicate (TEOS, Aldrich) and about 5 to about 10 moles of water, containing about 0.01 to about 0.1 moles of HCl is heated at about 50 to about 80° C, for a time sufficient to initiate condensation of the orthosilicate (e.g., about 2 to about 10 hours) to form a polysiloxane gel precursor composition. About 0.05 to about 0.5 moles of a carbohydrate such as sucrose is then added to the polysiloxane gel precursor solution to obtain a homogenous carbohydrate/silica aqueous sol-gel composition.

The carbohydrate/silica sol-gel composition is then spin coated onto a substrate such as silicon wafer, a metal plate, and the like, at about 1000 to about 3000 rpm, preferably at about 2000 rpm, to form a carbohydrate/silica nanocomposite film on the substrate. The resulting carbohydrate/silica nanocomposite film is then carbonized by heating the film at about 800 to about 1000° C. for about 1 to about 5 hours under an inert atmosphere (e.g., nitrogen, argon, and the like) to obtain a shining, black carbon/silica nanocomposite film.

A mesoporous carbon thin film is then prepared by removing the silica from the carbon/silica nanocomposite film, e.g., by treating the carbon/silica nanocomposite with dilute aqueous hydrofluoric acid, preferably about 1 percent by weight HF. The resulting carbon film has an open network of interconnecting pores having an average diameter of about 2 to about 3 nm, and no more than about 20% of the pores have diameters of less than about 1 nm.

Optionally, the film can be dried prior to carbonizing the carbohydrate. Drying can be achieved by simply allowing the sol-gel film to stand in ambient atmosphere at ambient room temperature for about 1 to 3 days, or by heating in an oven at about 100° C. for about an hour, if desired. Generally, if spin-coating is used to deposit the film, there is no need to dry the film before carbonization, since the spin-coating process inherently leads to water evaporation from the film.

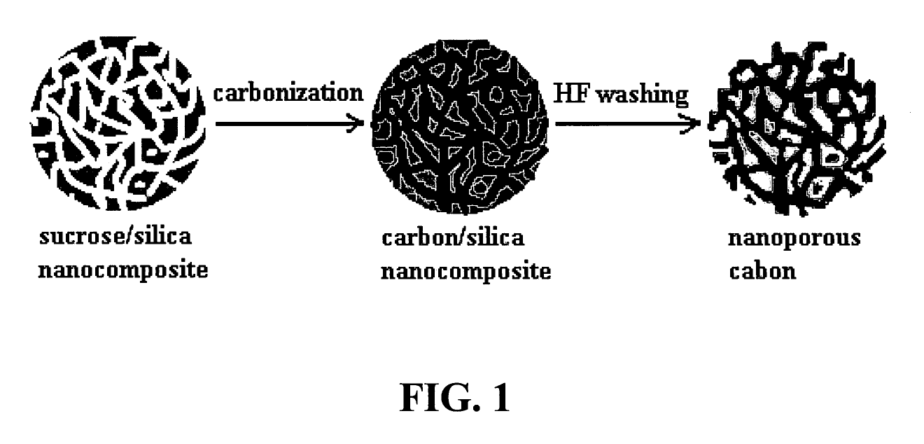

In another method aspect of the present invention, schematically illustrated in FIG. 2, a mesoporous carbon film having a hierarchical, bimodal pore structure is obtained by adding colloidal silica to the aqueous sol-gel composition used to form the carbohydrate/silica nanocomposite precursor film described above.

The method comprises depositing a thin film of an aqueous carbohydrate/silica sol-gel composition containing colloidal silica onto a substrate, the colloidal silica comprising substantially spherical particles having an average particle diameter in the range of about 10 to about 500 nm. The sol-gel composition is a homogeneous mixture containing about 30 to about 50 percent by weight water, about 1 to about 10 percent by weight of colloidal silica, about 30 to about 45 percent of a polysiloxane gel precursor on a silica equivalent weight basis, and about 3 to about 30 percent of water soluble carbohydrate on a carbon equivalent weight basis. The carbon/silica nanocomposite film is then heated at a temperature in the range of about 800 to about 1000° C. for a time sufficient to carbonize the carbohydrate in the thin film to form a carbon/silica nanocomposite film. The silica is removed from the carbon/silica nanocomposite film to provide a hierarchical bimodal mesoporous carbon film. The relative amounts of colloidal silica, polysiloxane gel precursor, and water soluble carbohydrate in the sol-gel composition are selected such that the carbon/silica nanocomposite film has a calculated carbon to silica weight ratio in the range of about 1:1 to about 1:7, preferably about 1:2.3 to about 1:7. The carbon to silica ratio of the carbon/silica nanocomposite film will typically have a value in the range of about 1:1 to about 1:11 as determined by thermogravimetric analysis.

Such hierarchical, bimodal mesoporous carbon films comprise a film of carbon defining an open network of interconnected primary pores arrayed in a uniform, random manner throughout the film, and further defining a plurality of substantially spherical secondary pores arrayed in a uniform, random manner throughout the film. The primary pores have an average pore diameter in the range of about 2 to about 3 nm, while the secondary pores preferably have an average diameter in the range of about 10 to about 500 nm, more preferably about 20 to about 100 nm. The diameters of the primary pores have a substantially unimodal pore diameter distribution and not more than about 20% of the primary pores have a diameter of less than about 1 nm. Additionally, the secondary pores interconnect with the network of primary pores.

The particle size distribution of the colloidal silica controls the pore size distribution of the substantially spherical secondary pores in the carbon film, since the secondary pores are formed by removal of the colloidal silica particles from the carbon/silica nanocomposite. Density of secondary pores in the film (i.e., the number of secondary pores per cubic centimeter) is controlled by the concentration of the colloidal silica in the sol-gel composition.

A preferred general procedure for preparing a hierarchical, bimodal mesoporous carbon film of the invention (on a 1 mole basis for the orthosilicate) follows. Any desirable amount of the film can be prepared by direct scale-up of the molar amounts provided below.

About one mole of an orthosilicate such as tetraethyl orthosilicate (TEOS, Aldrich) and about 5 to about 10 moles of water, containing about 0.01 to about 0.2 moles, preferably about 0.1 to about 0.2 moles of HCl, is heated at about 50 to about 80° C., for about 2 to about 10 hours, to form a polysiloxane gel precursor composition. About 0.05 to about 0.5 moles of a carbohydrate such as sucrose is then added to the polysiloxane gel precursor to obtain a homogenous carbohydrate/silica aqueous sol-gel composition. An amount of colloidal silica sufficient to obtain a desired secondary pore density is then added, with mixing, to the sol-gel composition. Preferably the colloidal silica is added in an amount such that the sol-gel composition contains between about 1 and 10 weight percent of colloidal silica, The particle size of the colloidal silica is selected based on the secondary pore size desired in the mesoporous carbon film. Colloidal silica is commercially available in a wide variety of pore sizes.

The carbohydrate/silica sol-gel composition containing colloidal silica is then spin-coated onto a substrate such as silicon, a metal, and the like, at about 1000 to about 3000 rpm, preferably about 2000 rpm, to form a carbohydrate/silica nanocomposite film on the substrate. The resulting carbohydrate/silica nanocomposite film is then heated at about 800 to about 1000° C., for a time sufficient to carbonize the carbohydrate, typically for about 2 to about 5 hours, under an inert atmosphere, to obtain a shining, black carbon/silica nanocomposite film.

A bimodal mesoporous carbon thin film is then prepared by removing the silica from the carbon/silica nanocomposite film, e.g., by treating the carbon/silica nanocomposite with dilute aqueous hydrofluoric acid, preferably about 1 percent by weight HF.

The mesoporous carbon films of the present invention are useful in a variety of applications, for example, as ultrafiltration membranes, as gas separation membranes, as catalyst support media, as hydrogen storage media, and the like.

The mesoporous carbon films of the present invention are stable over a wide pH range, making these films versatile materials for use in chemical separations and catalysis.

For example, the mesoporous carbon films of the present invention have application as ultrafiltration membranes. For this application, mesoporous carbon films can be fabricated simply by depositing the sol-gel composition onto a porous substrate, such as a porous alumina or porous stainless steel plate or tube, followed by carbonization and removal of silica. The resulting supported mesoporous carbon film can be fixed in a filtration device and directly used as a filter for gas or molecular separation, by passing a mixture of molecules through the supported film. By analyzing the components passing through the membrane, the filtration performance can be readily determined. Bimodal mesoporous carbon films can be prepared for separation of different molecules by varying the pore diameters of the secondary pore to accommodate different size molecules.

The mesoporous carbon films of the present invention can also be used in catalysis applications. For example, mesoporous carbon films impregnated with metal catalysts can be synthesized by simply incorporating a catalyst precursor (e.g., one or more transition metal salts or a colloidal metal) in the sol-gel composition, followed by depositing the sol-gel on a substrate, carbonization, and silica removal. The resulting catalyst-impregnated mesoporous carbon films can be fabricated on either nonporous substrates such as silicon wafers, or porous substrates, such as porous alumina or porous stainless steel. The supported catalyst-bearing mesoporous carbon films can be directly used as a catalytic bed for reactions, such as hydrogenation, when a reacting mixture passes over or through the supported mesoporous carbon film. Alternatively, the carbon films can be ground into a powder after carbonization, if desired.

In yet another application, a mesoporous carbon film of the present invention can be used as a hydrogen storage medium. Carbon-based materials are of much interest in hydrogen storage applications due to their low mass density. So far, pure or alkali-doped graphite nanotubes and pure or alkali-doped graphite nanofibers have aroused tremendous interest in the development of hydrogen storage materials.

The following non-limiting examples are provided to further illustrate preferred embodiments of the invention.

Characterization of Mesoporous Carbon Films.

The morphology and structure of the thin films were characterized using scanning electron microscopy (SEM, JEOL JSM-5410, operated using 20 kV voltage), atomic force microscopy (AFM, Molecular Imaging PicoScan 5, operated using the MAC mode), and transmission electron microscopy (TEM, JEOL 2010, operated at 120 kV voltage). The porosity of the mesoporous carbon was measured by nitrogen sorption technique at a temperature of about 77 K (Micromeritics, ASAP 2010). The samples were degassed at a temperature of about 200° C. and at a pressure of less than about 1.33 Pa for several hours prior to the measurement. Specific surface areas were determined using the Brunauer-Emmett-Teller (BET) equation in the P/PO range of about 0.06 to about 0.20. Pore volumes were determined using the amount of nitrogen uptake at the P/PO of about 0.975. The surface area and pore volume of the pores with pore diameters in the range of about 2.0 to about 50 nm were analyzed using the Barrett-Joyner-Halenda (BJH) method and the adsorption isotherms, as is well known in the art. Compositions of the carbon/silica nanocomposites and mesoporous carbon films were determined by thermal gravimetric analysis (TGA, TA Hi-Res TGA 2950) and X-ray energy dispersive spectrometry (EDS, Oxford Link ISIS 6498 spectrometer). The samples were heated form ambient room temperature to about 1000° C. in oxygen to convert the carbon in the sample to carbon dioxide, which volatilized from the sample. An oxygen flow of about 80 mL/min and a heating rate of about 5° C./min were used in the TGA assays. The weight loss of the sample observed during the TGA analysis corresponds to the carbon content of the carbon/silica nanocomposite film. The weight of the sample after the TGA cycle is complete corresponds to the weight of silica in the film. The ratio of the carbon weight to silica weight provides the measured carbon to silica weight ratio for the film.

### EXAMPLE 1

### Preparation of a Unimodal Mesoporous Carbon Film

About 2.1 g (about 0.01 mol, equivalent to about 0.6 g of SiO₂) of tetraethyl orthosilicate (Aldrich), about 1.8 g (about 0.10 mol) of water, and about 0.21 g of 1 N HCl (about 0.0002 mol HCl were reacted at about 60° C. for about 6 hours. About 0.61 g of sucrose (about 0.00178 mol, equivalent to about 0.26 g of carbon) was then added to achieve a homogenous aqueous sol-gel composition. A sucrose/silica nanocomposite film was prepared by spin coating the sol-gel composition at about 2000 rpm onto a silicon wafer. The resulting sucrose/silica nanocomposite thin film was then heated at about 900° C. for about 4 hours under a nitrogen atmosphere to afford a shining black carbon/silica nanocomposite film having a calculated carbon to silica weight ratio of about 1:2.3. A mesoporous carbon thin film (Film C-4 in Table 1) was obtained by removing the silica from the carbon/silica nanocomposite films by washing the film with dilute aqueous HF (about 1 percent by weight HF). For comparison, a mesoporous silica film was also prepared by calcining the carbonized nanocomposites in oxygen at about 600° C. to fully oxidize and remove the carbon from the film.

Other mesoporous carbon/silica nanocomposite films were cast using the same general procedure. The carbon to silica ratios (calculated and TGA-measured), specific surface areas and specific pore volumes are provided in Table 1 for each film.

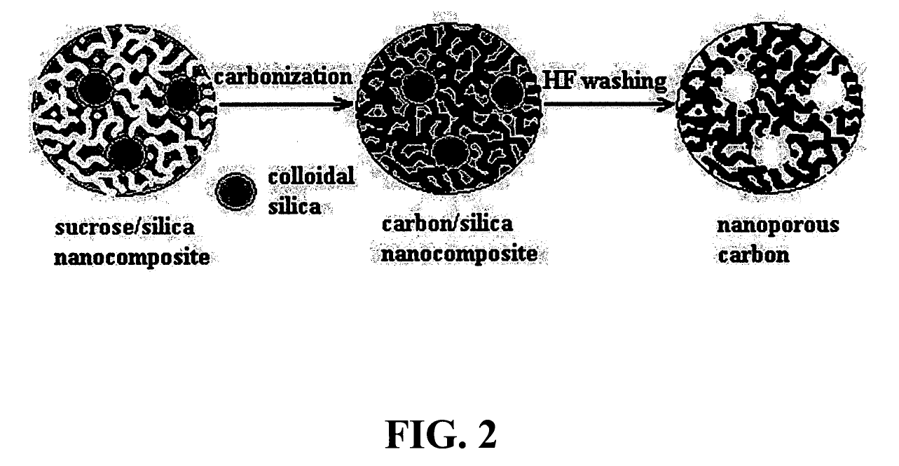

The carbonized films, before and after removal silica, were characterized by TGA (Table 1). FIG. 3 shows the TGA data for Film C-4. The observed weight loss of about 26% for the carbon/silica nanocomposite in FIG. 3 is consistent with nearly complete oxidative removal of the carbon from the carbon/silica nanocomposite film. As can be seen in Table 1, the carbon to silica weight ratio determined by TGA is generally somewhat lower than the theoretical value, most likely due to incomplete carbonization of the sucrose. The mesoporous carbon Film C-4 exhibited a weight loss of about 98%, indicating that the silica had been essentially completely removed by the HF treatment, which agrees well with the results obtained by EDS analysis.

TABLE 1

| | | Carbon content | | | | Specific | Specific |
|---|---|---|---|---|---|---|---|
| | Amount | Calculated | | Measured | | Surface | Pore |
| | Sucrose | [b] | | [c] | | Area | Volume |
| Sample | grams[a] | wt % | C/Si | wt % | C/Si | m²/g | cm³/g |
| C-1 | 1.503 | 51.24 | 1:1.0 | 44.60 | 1:1.2 | 1526 | 0.789 |
| C-2 | 1.200 | 45.67 | 1:1.2 | 37.96 | 1:1.6 | 1678 | 0.903 |
| C-3 | 0.893 | 38.24 | 1:1.6 | 30.00 | 1:2.3 | 2314 | 1.305 |
| C-4 | 0.608 | 29.48 | 1:2.3 | 26.00 | 1:2.8 | 2603 | 1390 |
| C-5 | 0.407 | 22.01 | 1:3.5 | 13.48 | 1:6.2 | 1076 | 0.717 |
| C-6 | 0.206 | 12.42 | 1:7.0 | 8.65 | 1:10.5 | 358 | 0.384 |

[a] The amount of SiO₂ derived from TEOS was fixed at 0.6 g.
[b] Calculated under the assumption that all the carbon atoms in the sucrose are transferred into carbon.
[c] Determined by TGA.

SEM and AFM images of the mesoporous carbon Film C-4 indicated that a continuous, smooth, crack-free thin film was formed. Cross-sectional SEM studies indicated an average film thickness of about 1 micron.

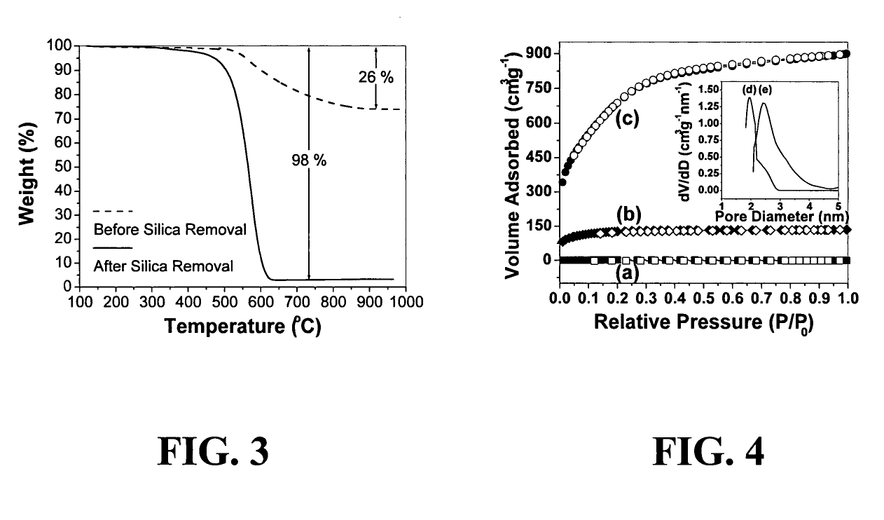

FIG. 4 shows the N₂ adsorption/desorption isotherms of (a) the silica/carbon nanocomposite precursor to Film C-4, (b) a nanoporous silica film prepared by removing the carbon from the carbon/silica nanocomposite, and (c) the mesoporous carbon Film C-4. The carbon/silica nanocomposite exhibited typical non-porous isotherms with non-detectable N₂ adsorption, indicating that the carbon/silica nanocomposites are dense to nitrogen at a temperature of about 77 K. Both the nanoporous silica film (b) and mesoporous carbon (c) exhibited isotherms without hysteresis loops. The observed lack of hysteresis and the absence of appreciable nitrogen adsorption at high relative nitrogen pressures are consistent with a narrow pore-size distribution. The mesoporous carbon Film C-4 exhibited a high specific surface area of about 2603 m²/g and a specific pore volume of about 1.39 cm³/g, while the nanoporous silica exhibited a specific surface area of about 460 m²/g and a specific pore volume of about 0.21 cm³/g. The inset in FIG. 4 shows the density functional theory (DFT) pore size distributions of the mesoporous silica and mesoporous carbon, which center at about 2.4 nm and 2 nm, respectively. At least about 90% of the pores in the mesoporous carbon Film C-4 had diameters within about 1 to about 2 nm. Films C-1, C-2, C-3, C-5, and C-6 had similar pore sizes and distributions.

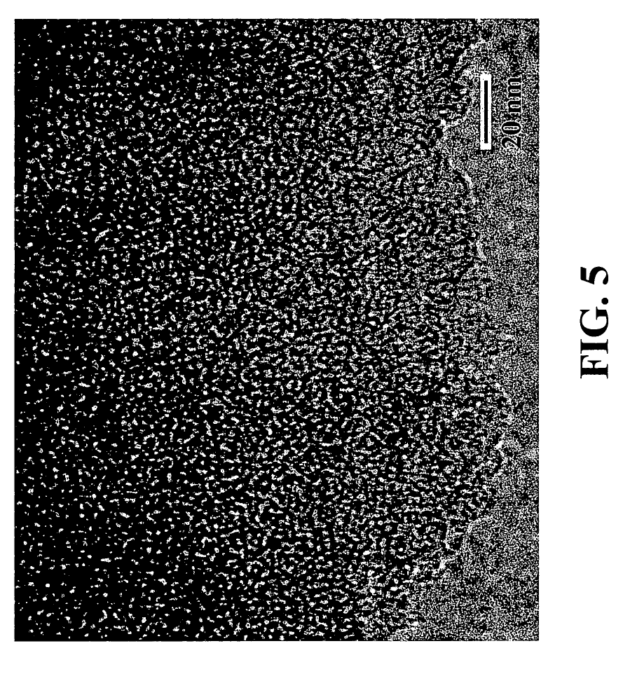

TEM studies of the mesoporous carbon Film C-4 (FIG. 5) revealed a disordered mesoporous structure with relatively uniform pore size. The pore diameter observed from the TEM was about 2 nm, which is consistent with that obtained from the nitrogen sorption assay.

### EXAMPLE 2

### Preparation of a Bimodal Mesoporous Carbon Film

A continuous mesoporous carbon film with hierarchical bimodal pore structure was prepared by incorporating colloidal silica particles as a secondary template, as illustrated in FIG. 2. About 2.1 g of tetraethyl orthosilicate (TEOS, Aldrich), about 2.0 g of water and about 0.51 g of 1 N HCl solution were reacted at about 60° C. for about 6 hours. About 0.6 g of sucrose was then added to achieve a homogenous sol-gel composition. Next, about 0.3 g of colloidal silica suspension (Nissan Chemicals, i.e., Snowtex-50, 20-30 nm, about 50% by weight in water) was added into the sol-gel composition with stirring and the mixture was ultrasonicated for about 5 minutes. A continuous mesoporous carbon film were prepared as described in Example 1, above.

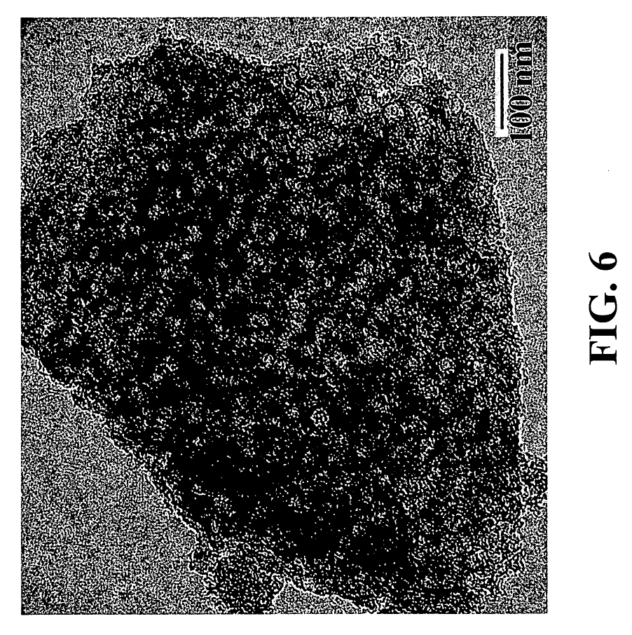

The resulting hierarchical, bimodal mesoporous carbon film was characterized by TEM (FIG. 6) of the nanoporous carbon shows the presence of the larger, secondary pores (e.g., 20-30 nm pore diameter) uniformly distributed within an open, interconnecting network of approximately 2 nm diameter primary pores.

### EXAMPLE 3

### Evaluation Hydrogen Storage Capacity of a Unimodal Mesoporous Carbon Film of the Present Invention

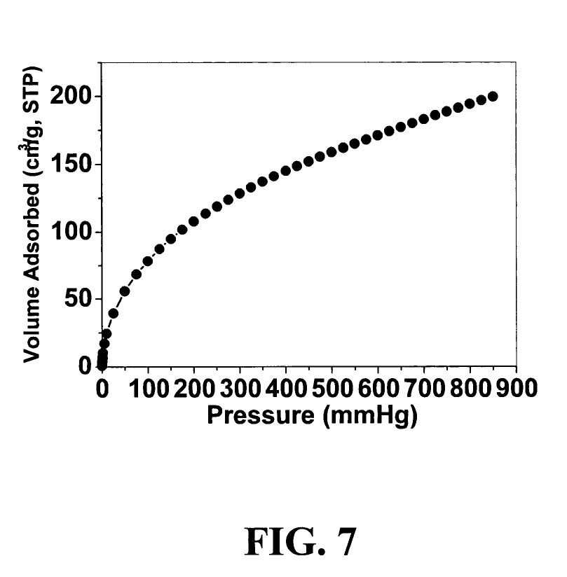

A unimodal mesoporous carbon film of the present invention was prepared by the methods described above. In order to facilitate the measurement of its hydrogen storage capacity, the film was ground into a powder. The hydrogen storage capacity of the ground film was evaluated on a Micromeritics 2010 instrument. FIG. 7 shows the hydrogen adsorption isotherm of the powdered mesoporous carbon film at an absolute pressure between about 0 to about 850.2 mmHg and at a temperature of about 77 K. FIG. 7 clearly shows that the hydrogen adsorption increases as the pressure increases, and reaches a final maximum of 199.63 cm³/g (STP H₂) at pressure of about 850.2 mmHg. The calculated gravimetric storage capacity of the ground film was about 1.8 percent by weight.

Numerous variations and modifications of the embodiments described above can be effected without departing from the spirit and scope of the novel features of the invention. No limitations with respect to the specific embodiments illustrated herein are intended or should be inferred.

1. A mesoporous carbon film comprising a film of carbon defining an open network of interconnected primary pores arrayed in a uniform, random manner throughout the film, the pores having an average pore diameter in the range of about 2 to about 3 nm, wherein the diameters of the pores have a substantially unimodal pore diameter distribution, and not more than about 20 percent of the pores have a diameter of less than about 1 nm.

2. The mesoporous carbon film of claim 1 wherein at least about 90 percent of the primary pores have a diameter in the range of about 1 to about 3 nm.

3. The mesoporous carbon film of claim 1 in the form of a powder.

4. The mesoporous carbon film of claim 1 wherein the film has a specific surface area in the range of about 300 to about 3000 m²/g.

5. The mesoporous carbon film of claim 1 wherein the film has a specific surface area in the range of about 2000 to about 3000 m²/g.

6. The mesoporous carbon film of claim 1 wherein the film has a specific pore volume in the range of about 0.7 to about 1.5 cm³/g.

7. The mesoporous carbon film of claim 1 wherein the film has a specific pore volume in the range of about 1 to about 1.5 cm³/g.

8. The mesoporous carbon film of claim 1 wherein the film has an average thickness in the range of about 0.5 to about 2 microns.

9. A mesoporous carbon film having a unimodal pore structure comprising a film of carbon defining an open network of interconnected pores arrayed in a uniform, random manner throughout the film, the pores having an average pore diameter in the range of about 2 to about 3 nm, wherein the diameters of the pores have a substantially unimodal pore diameter distribution, and not more than about 20 percent of the pores have a diameter of less than about 1 nm; the film having a specific surface area in the range of about 2000 to about 3000 m²/g and a specific pore volume in the range of about 1 to about 1.5 cm³/g.

10. A mesoporous carbon film having a hierarchical, bimodal pore structure comprising a film of carbon defining an open network of interconnected primary pores arrayed in a uniform, random manner throughout the film, and further defining a plurality of substantially spherical secondary pores arrayed in a uniform, random manner throughout the film; the primary pores having an average pore diameter in the range of about 2 to about 3 nm; the secondary pores having an average diameter in the range of about 10 to about 500 nm; wherein the diameters of the primary pores have a substantially unimodal pore diameter distribution, not more than about 20 percent of the primary pores have a diameter of less than about 1 nm, and the secondary pores interconnect with the network of primary pores.

11. The mesoporous carbon film of claim 10 wherein at least about 90 percent of the primary pores have a diameter in the range of about 1 to about 3 nm.

12. The mesoporous carbon film of claim 10 wherein the secondary pores have an average diameter in the range of about 20 to about 100 nm.

13. The mesoporous carbon film of claim 10 wherein the secondary pores have an average diameter in the range of about 20 to about 30 nm.

14. The mesoporous carbon film of claim 10 wherein the film has a specific surface area in the range of about 300 to about 3000 m²/g.

15. The mesoporous carbon film of claim 10 wherein the film has a specific surface area in the range of about 1000 to about 2000 m²/g.

16. The mesoporous carbon film of claim 10 wherein the film has a specific pore volume in the range of about 1 to about 2 cm³/g.

17. The mesoporous carbon film of claim 10 wherein the film has a specific pore volume in the range of about 1 to about 1.5 cm³/g.

18. The mesoporous carbon film of claim 1 wherein the film has an average thickness in the range of about 0.5 to about 2 microns.

19. A mesoporous carbon film having a hierarchical, bimodal pore structure comprising a film of carbon defining an open network of interconnected primary pores arrayed in a uniform, random manner throughout the film, and further defining a plurality of substantially spherical secondary pores arrayed in a uniform, random manner throughout the film; the primary pores having an average pore diameter in the range of about 2 to about 3 nm; the secondary pores having an average diameter in the range of about 20 to about 30 nm; wherein the diameters of the primary pores have a substantially unimodal pore diameter distribution, not more than about 20 percent of the primary pores have a diameter of less than about 1 nm, and the secondary pores interconnect with the network of primary pores.

20. A method of preparing a mesoporous carbon film, the method comprising the steps of:
(a) depositing a thin film of an aqueous carbohydrate/silica sol-gel composition onto a substrate; the sol-gel composition being a homogeneous mixture containing about 30 to about 40 percent by weight water, about 35 to about 50 percent of a polysiloxane gel precursor on a silica equivalent weight basis, and about 4 to about 30 percent of water soluble carbohydrate on a carbon equivalent weight basis, the relative amounts of polysiloxane gel precursor and water soluble carbohydrate in the sol-gel composition being selected such that the carbon/silica nanocomposite film of step (b) has a carbon to silica weight ratio in the range of about 1:1 to about 1:11, as determined by thermogravimetric analysis;
(b) heating the thin film of step (a) at a temperature in the range of about 800 to about 1000° C. for a time sufficient to carbonize the carbohydrate in the thin film to form a carbon/silica nanocomposite film; and
(c) removing the silica from the carbon/silica nanocomposite film to provide a carbon film defining an open network of interconnected primary pores arrayed in a uniform, random manner throughout the carbon film, the pores having an average pore diameter in the range of about 2 to about 3 nm, the diameters of the pores having a substantially unimodal pore diameter distribution, and not more than about 20 percent of the pores having a diameter of less than about 1 nm.

21. The method of claim 20 wherein the water soluble carbohydrate is sucrose.

22. The method of claim 20 wherein the polysiloxane gel precursor is formed in situ by heating an acidic, aqueous solution of an orthosilicate at a temperature in the range of about 50 to about 80° C. for about 2 to about 10 hours.

23. The method of claim 20 wherein the carbohydrate/silica nanocomposite is heated at a temperature of about 900° C. for about 4 hours in step (b).

24. The method of claim 20 wherein the silica is removed in step (c) by contacting the carbon/silica nanocomposite film with dilute aqueous hydrofluoric acid.

25. The method of claim 20 wherein the thin film of step (a) is deposited by spin coating the sol-gel composition onto the substrate.

26. A method of preparing a mesoporous carbon film having a hierarchical, bimodal pore structure, the method comprising the steps of:
(a) depositing a thin film of an aqueous carbohydrate/silica sol-gel composition containing colloidal silica onto a substrate, the colloidal silica comprising substantially spherical particles having an average particle diameter in the range of about 10 to about 500 nm; the sol-gel composition being a homogeneous mixture containing about 30 to about 50 percent by weight water, about 1 to about 10 percent by weight of colloidal silica, about 30 to about 45 percent of a polysiloxane gel precursor on a silica equivalent weight basis, and about 3 to about 30 percent of water soluble carbohydrate on a carbon equivalent weight basis, the relative amounts of colloidal silica, polysiloxane gel precursor, and water soluble carbohydrate in the sol-gel composition being selected such that the carbon/silica nanocomposite film of step (b) has a carbon to silica weight ratio in the range of about 1:1 to about 1:11, as determined by thermogravimetric analysis;
(b) heating the thin film of step (a) at a temperature in the range of about 800 to about 1000° C. for a time sufficient to carbonize the carbohydrate in the thin film to form a carbon/silica nanocomposite film; and
(c) removing the silica from the carbon/silica nanocomposite film to provide a carbon film defining an open network of interconnected primary pores arrayed in a uniform, random manner throughout the carbon film, and further defining a plurality of substantially spherical secondary pores arrayed in a uniform, random manner throughout the carbon film; the primary pores having an average pore diameter in the range of about 2 to about 3 nm; the secondary pores having an average diameter in the range of about 10 to about 500 nm; wherein the diameters of the primary pores have a substantially unimodal pore diameter distribution, not more than about 20 percent of the primary pores have a diameter of less than about 1 nm, and the secondary pores interconnecting with the network of primary pores.

27. The method of claim 26 wherein the carbohydrate is sucrose.

28. The method of claim 26 wherein the polysiloxane gel precursor is formed in situ by heating an acidic solution of an orthosilicate at a temperature in the range of about 50 to about 80° C. for about 2 to about 10 hours.

29. The method of claim 26 wherein the carbohydrate/silica nanocomposite is heated at a temperature of about 900° C. for about 4 hours in step (b).

30. The method of claim 26 wherein the colloidal silica has an average particle size in the range of about 20 to about 30 nm.

31. The method of claim 26 wherein the silica is removed in step (c) by contacting the carbon/silica nanocomposite film with dilute aqueous hydrofluoric acid.

32. The method of claim 26 wherein the thin film of step (a) is deposited by spin coating the sol-gel composition onto the substrate.

33. An ultrafiltration membrane comprising a mesoporous carbon film of claim 1 on a porous support.

34. An ultrafiltration membrane comprising a mesoporous carbon film of claim 10 on a porous support.

35. A gas separation membrane comprising a mesoporous carbon film of claim 1 on a porous support.

36. A gas separation membrane comprising a mesoporous carbon film of claim 10 on a porous support.

37. A catalytic membrane comprising a mesoporous carbon film of claim 1 impregnated with a metallic catalyst.

38. A catalytic membrane comprising a mesoporous carbon film of claim 10 impregnated with a metallic catalyst.

39. A hydrogen storage medium comprising a mesoporous carbon film of claim 1.

40. A hydrogen storage medium comprising a mesoporous carbon film of claim 1 in the form of a powder.

41. A hydrogen storage medium comprising a mesoporous carbon film of claim 10.

42. A hydrogen storage medium comprising a mesoporous carbon film of claim 10 in the form of a powder.
